(19) United States
(12) Patent Application Publication
(10) Pub. No.: US 2016/0323507 A1
(43) Pub. Date: Nov. 3, 2016

(54) METHOD AND APPARATUS FOR GENERATING MOVING PHOTOGRAPH

(71) Applicant: Seerslab, Inc., Seoul (KR)

(72) Inventors: Jin Wook Chong, Seoul (KR); Jae Cheol Kim, Seoul (KR)

(73) Assignee: Seerslab, Inc., Seoul (KR)

(21) Appl. No.: 15/141,354

(22) Filed: Apr. 28, 2016

(30) Foreign Application Priority Data
Apr. 29, 2015 (KR) 10-2015-0060862
Jan. 5, 2016 (KR) 10-2016-0001023

(51) Int. Cl. H04N 5/232; H04N 5/77

(52) U.S. Cl. CPC H04N 5/23245; H04N 5/77; H04N 5/23293

(57) ABSTRACT

Provided is a method of generating a moving photograph, which includes displaying a subject photographed by a camera; switching to a moving photograph mode in response to an input of a user; progressively taking photographs of the displayed subject by using a photographing mode provided by the moving photograph mode; and generating a moving image of the displayed subject by using the progressively taken photographs.

### CROSS-REFERENCE TO RELATED APPLICATIONS

A claim for priority under 35 U.S.C. §119 is made to Korean Patent Application No. 10-2015-0060862, filed on Apr. 29, 2015, and Korean Patent Application No. 10-2016-0001023, filed on Jan. 5, 2016, in the Korean Intellectual Property Office, the entire contents of which are hereby incorporated by reference.

### BACKGROUND

Embodiments of the inventive concept described herein relate to the generation of a moving photograph and, more particularly, relate to a method and apparatus for generating a moving photograph, which are capable of automatically generating a moving photograph of a subject by using a plurality of photographs obtained by progressively photographing the subject.

The concept of cinemographs was first introduced by the Harry Potter series of J. K. rolling in 1997, and then cinemographs were popularized by photographer Jamie Beck and graphic artist Kevin Burg, who were working in New York, in 2011. Cinemographs may be viewed as an intermediate form between photographs and moving images, and are characterized in that only part of a photograph is continuously played back.

Cinemographs are designed to continuously play back part of a photograph so that only part of the photograph moves. A plurality of photographs, such as a photograph in which part of a subject is stopped and a photograph, in which the movement of part of the subject has occurred, is required in order to infinitely play back part of a photograph, and a moving photograph is generated by editing the plurality of photographs.

That is, in the case of cinemographs, a moving photograph is generated by moving only a specific object included in a subject without using an additional effect.

However, cinemographs are problematic in that the generation of moving photographs is complicated and persons lacking relevant expert knowledge cannot generate moving photographs because editing is performed using a plurality of photographs of a subject to allow only a specific object to move and then the result thereof is applied.

### SUMMARY

Embodiments of the inventive concept provide a method and apparatus for generating a moving photograph, which are capable of automatically generating a moving photograph of a subject by using a plurality of photographs obtained by progressively photographing the subject.

In detail, embodiments of the inventive concept provide a method and apparatus for generating a moving photograph, which are capable of automatically generating a moving photograph of a subject by using a plurality of photographs obtained by progressively photographing the subject when a specific mode is selected after switching to a mode for generating a moving photograph.

One aspect of embodiments of the inventive concept is directed to provide a method of generating a moving photograph, which includes: displaying a subject photographed by a camera; switching to a moving photograph mode in response to an input of a user; progressively taking photographs of the displayed subject by using a photographing mode provided by the moving photograph mode; and generating a moving image of the displayed subject by using the progressively taken photographs.

When a first mode is selected from photographing modes provided in the moving photograph mode, the taking of the photographs is performed by progressively taking a predetermined number of photographs in the first mode.

When a second mode is selected from photographing modes provided in the moving photograph mode, the taking of the photographs is performed by photographing the displayed subject by using a video function for a time set by the user.

In addition, the method further includes displaying the generated moving photograph, and when a storage button configured to store the generated moving photographs is selected by the user, storing the moving photograph in a graphics interchange format (GIF) file.

In addition, the method further includes, when the user selects one from effects, applying the selected effect to the displayed subject, wherein the taking of the photographs is performed by progressively photographing the subject to which the selected effect is applied.

In addition, the applying of the selected effect includes determining a location in the subject to which the selected effect is applied, based on an object included in the subject, and applying the selected effect to the determined application location.

Another aspect of embodiments of the inventive concept is directed to provide an apparatus for generating a moving photograph, which includes: a display unit configured to display a subject photographed by a camera; a switch unit configured to switch to a moving photograph mode in accordance with an input of a user; a photographing unit configured to progressively taking photographs of the displayed subject by using a photographing mode provided by the moving photograph mode; and a generation unit configured to generate a moving image of the displayed subject by using the photographs progressively taken.

When a first mode is selected from photographing modes provided in the moving photograph mode, the photographing unit progressively takes a predetermined number of photographs of the displayed subject in the first mode.

When a second mode is selected from photographing modes provided in the moving photograph mode, the photographing unit takes photographs the displayed subject by using a video function for a time set by the user.

In addition, the apparatus further includes a storage unit configured to store the moving photograph in a Graphics Interchange Format (GIF) file when a storage button configured to store the generated moving photograph is selected by the user in a state that the generated moving photograph is displayed on the display unit.

In addition, the apparatus further includes an application unit configured to apply an effect to the displayed subject when the user selects the effect from effects, wherein the photographing unit progressively photographs the subject to which the selected effect is applied.

In addition, the application unit determines a location in the subject to which the selected effect is applied, based on an object included in the subject, and applies the selected effect to the determined application location.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a view illustrating an embodiment;

FIGS. 2 and 3 are flowcharts illustrating a method of generating a moving photograph according to an embodiment;

FIGS. 4 and 5 are views illustrating a mode switching process;

FIGS. 6 to 8 are views illustrating a process of generating a moving photograph through the photographing in a GIF mode.

FIGS. 9 to 12 are views illustrating a process of generating a moving photograph by applying a moving effect; and

FIG. 13 is a block diagram illustrating the configuration of an apparatus for generating a moving photograph according to an embodiment of the present invention.

### DETAILED DESCRIPTION

Hereinafter, embodiments of the inventive concept will be described in detail with reference to the accompanying drawings. However, the inventive concept is not limited or restricted by these embodiments. Furthermore, throughout the drawings, the same reference symbols designate the same components.

The present invention is intended to generate a moving photograph based on a moving effect, and is characterized by applying a moving effect to a subject and then generating a moving photograph in which the subject is maintained in a captured state and only the moving effect is moving.

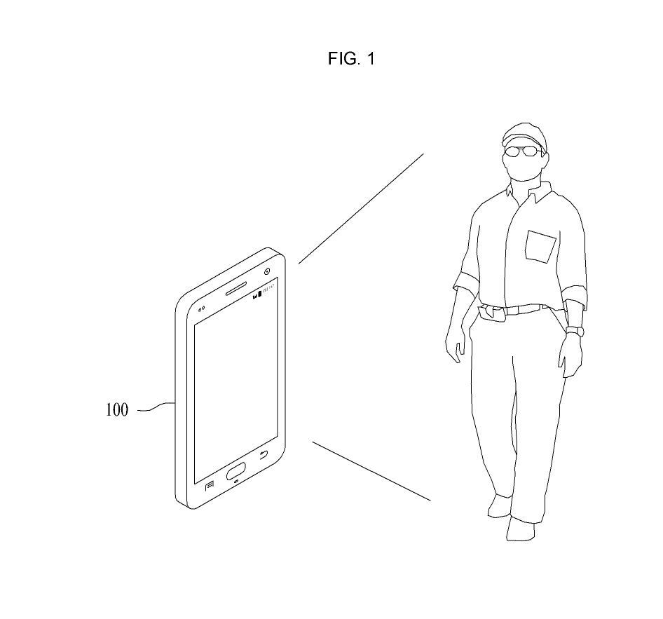

FIG. 1 is a view illustrating the inventive concept.

As shown in FIG. 1, the embodiment may be applied to a device 100 equipped with a camera, such as a smart phone. When a subject is photographed by using a camera, the embodiment, which is installed to a smart phone in the form of an application, may provide a general photographing mode capable of taking a conventional photograph or video and a moving photograph mode such as a graphics interchange format (GIF) photographing mode capable of generating a moving photograph of a subject by using a plurality of photographs progressively taken, such that a moving photograph of the subject is automatically generated in a GIF file format by using the moving photograph mode.

In advance, an embodiment may provide effects including a moving effect to a general photographing mode and a moving photograph mode and may generate a moving photograph even in the general photographing mode by using the moving effect. Of course, when a video is taken in the general photographing mode and the moving effect is applied, the moving effect may be applied as it is.

The moving photograph mode according to an embodiment may include a first mode such as a GIF burst mode in which the predetermined number of photographs are automatically and progressively taken by using a photographing function and a moving photograph of a subject is automatically generated in a GIF file format by using the photographs progressively taken and a GIF video mode in which a video (which may include a plurality of video frames of the subject or a plurality of photographs) is taken for a time determined in response to an input of a user and a moving photograph is automatically generated in a GIF file format by using the video taken. In the following description, it is assumed in the embodiment that the moving photograph mode is a GIF photographing mode and the GIF photographing mode includes the GIF burst mode using the photographing function and the GIF video mode using a video-graphing mode.

In this case, the subject may include various objects, such as a human, a building, an automobile, etc. The location, at which an effect is applied in the general photographing mode and the GIF photographing mode, may be determined based on the information about the effect selected by a user and the information about an object included in the subject to be photographed.

In the following description, for the purpose of convenient description, the embodiment will be described as being performed in a smart phone equipped with a camera. It will be apparent to those skilled in the art that the present invention is not limited to the smart phone but may be applied to all devices on which the present invention may be installed.

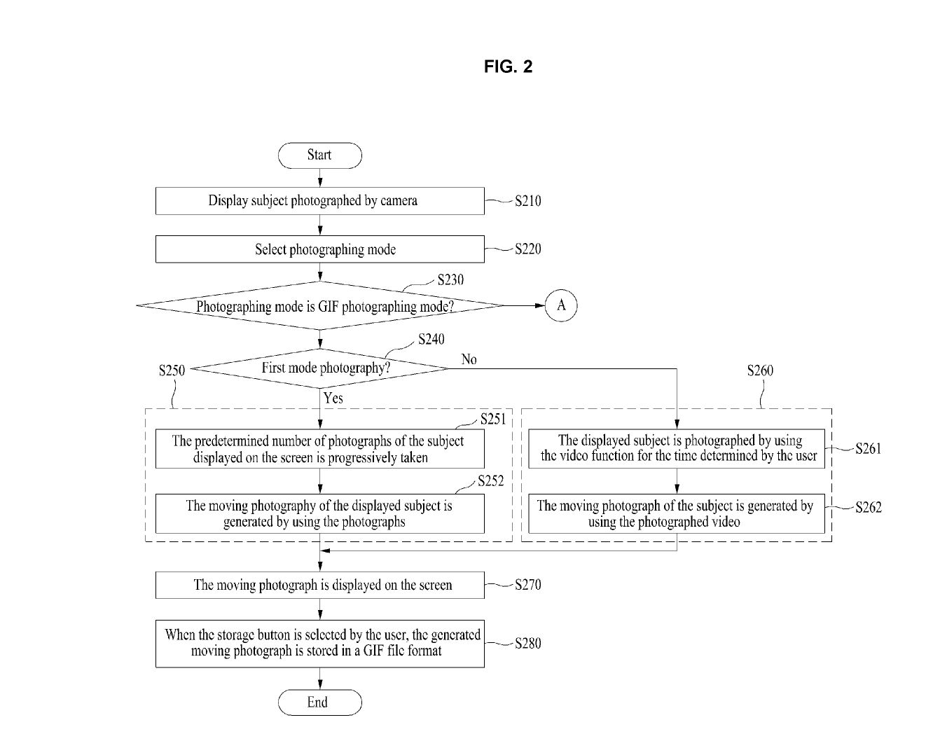

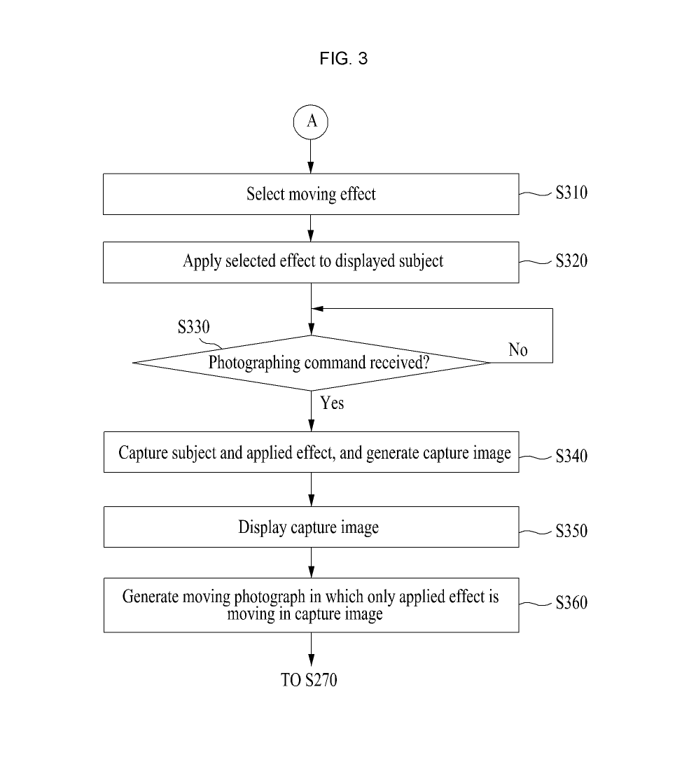

FIGS. 2 and 3 are operation flowcharts illustrating a method of generating a moving photograph according to an embodiment.

Referring to FIGS. 2 and 3, according to the method of generating a moving photograph of the embodiment, in step S210, an application related to the inventive concept is executed, and a subject photographed by the camera of a device to which the application is installed, for example, a subject including an object, such as an automobile, scenery, a human or the like, is displayed on a screen.

Various filter functions may be applied to the subject displayed in the step S210 in response to a user's selection, and the various functions of the camera configured to photograph a subject may be applied to the subject.

When the subject is displayed on the screen in the step S210, it is determined in steps S220 and S230 whether the photographing mode selected through an input of the user is the GIF photographing mode or the general photographing mode.

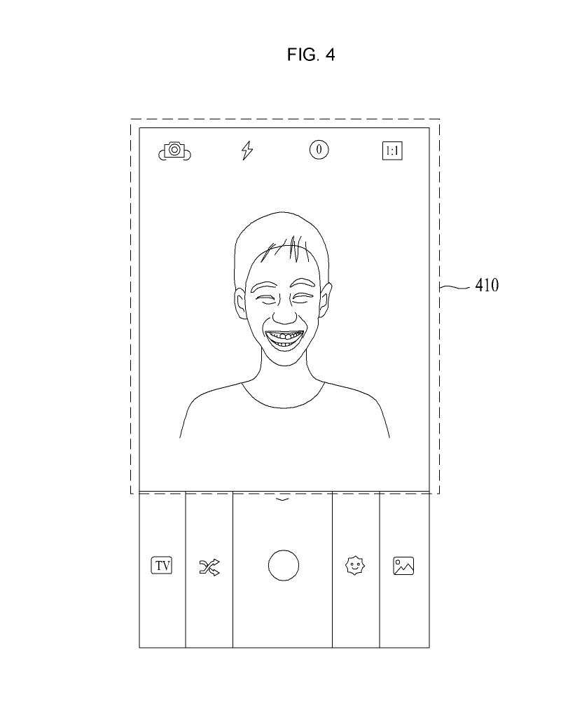

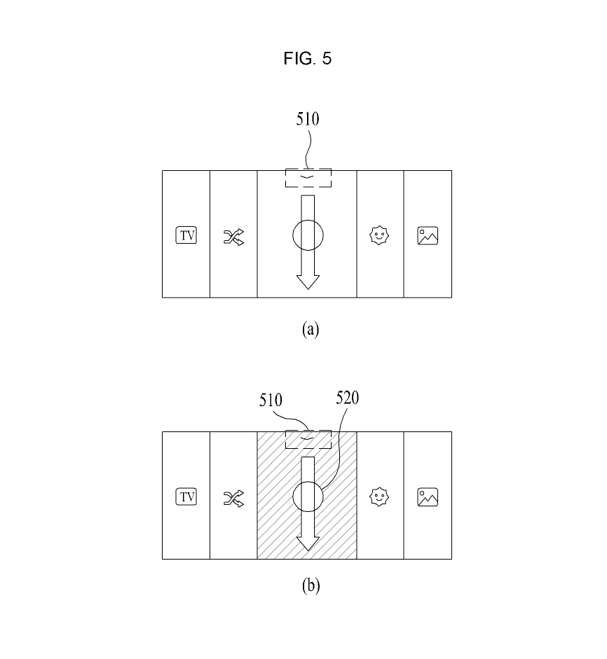

For example, as shown in FIG. 4, when the subject to be photographed is displayed on the screen 410 and a mode switching function provided on the screen is selected through a user input, it may be determined which photographing mode is selected. For example, as shown in FIG. 5A, in a state that the general photographing mode is basically set, when a switch button 510 configured to perform switching between the general photographing mode and the GIF photographing mode slides downward in an arrow direction, as shown in FIG. 5B, while the mode switches to the GIF photographing mode, a color of an area including a photographing button 520, which is information representing the GIF photographing mode, is changed from a first color such as white to a second color such as yellow. Of course, when the switch button 510 slides downward in the arrow direction as shown in FIG. 5B, while the mode switches to the general photographing mode of FIG. 5A, the color of the area including the photographing button 520, which is information representing the general photographing mode, is changed from the second color such as yellow to the first color such as white.

Although FIG. 5 illustrates that the switch button 510 on the photographing button slides by a photographing mode switching function, the embodiment is not limited thereto and the function or button configured to switch a photographing mode may be implemented in software in a separated area or through a hardware switch. That is, user interfaces may be configured to be different from each other in accordance with a switched photographing mode. For example, the photographing mode switching function may be performed through a selecting mode of a button or toggle type.

As the determination result of the step S230, when it is determined that the photograph mode is the GIF photographing mode, it is determined in step S240 whether the photographing scheme in the GIF photograph mode is first mode photography (GIF burst mode) or second mode photography.

In this case, it may be determined whether the photographing scheme is the first or second mode photography, based on the touch time of a photographing button 520 depicted in FIG. 5. For example, when the photographing button 520 is touched once for a shorter time than a predetermined time, the GIF burst mode photography may be performed. When the photographing button 520 is touched for a longer time than the predetermined time, the GIF video mode photography may be performed. Of course, the embodiment is not limited to the scheme of determining the GIF burst mode photography or the GIF video mode photography described above.

As the determination result of the step S240, when the GIF burst mode is executed in response to a user input, a moving photograph of the displayed subject is generated through the GIF burst mode photography in step S250. In detail, the predetermined number of photographs of the subject displayed on the screen is progressively taken in the step S250, and the moving photography of the displayed subject is generated by using the photographs in steps S251 and S252.

When the moving photograph of the displayed subject is generated in the step S250, the generated moving photograph is displayed on the screen. In steps S270 and S280, when a storage button previously provided is selected, the moving photograph is stored in a GIF file format.

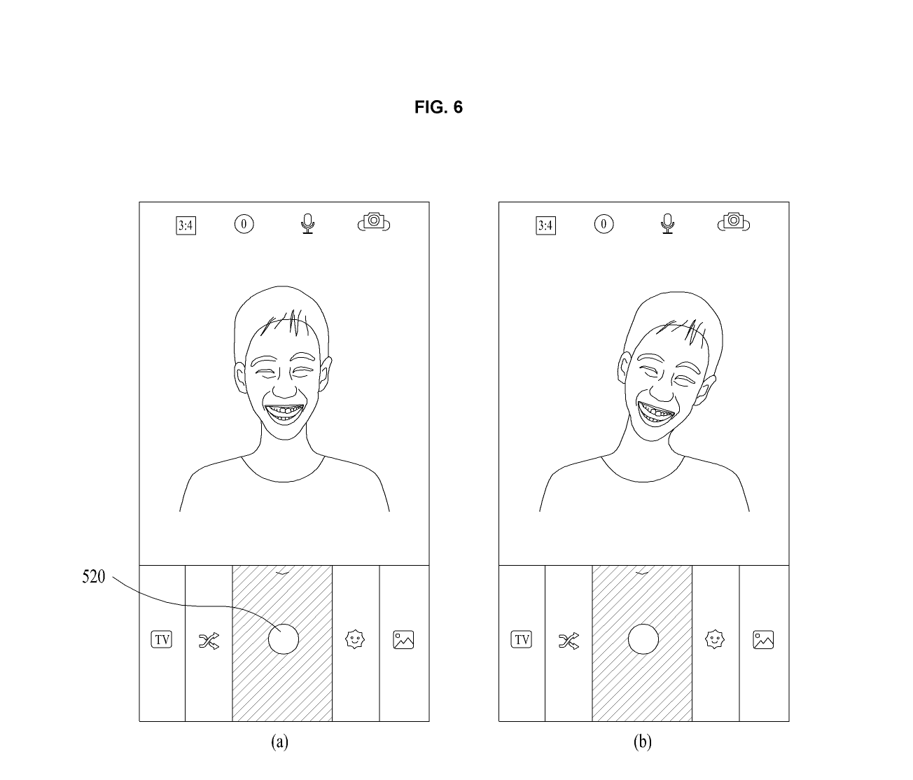

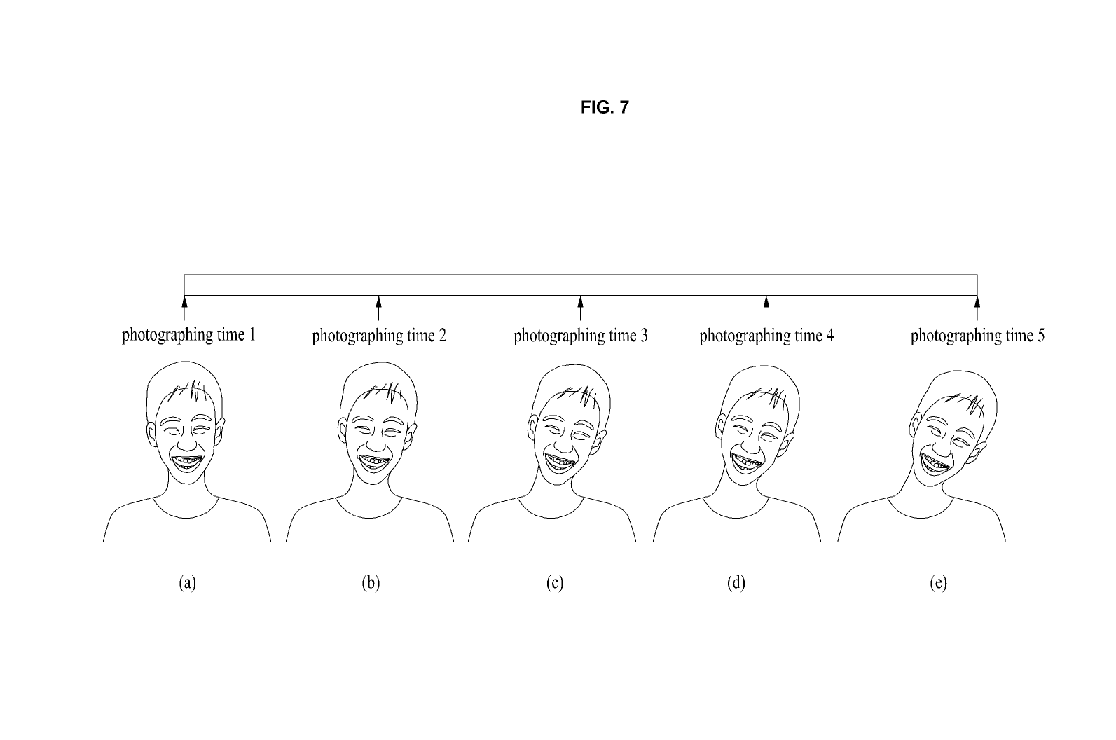

For example, as shown in FIG. 6A, when the user selects the photographing button 520 for a shorter time than the predetermined time, the photographing is initiated in the GIF burst mode and the predetermined number of photographs are taken, for example, the photographs are progressively taken five times every a predetermined time. In this case, as shown in FIG. 6B, when the user's head turns in one direction for the time taken to photograph 5 times, the photographs of the subject taken in the GIF burst mode are shown in FIG. 7. That is, as shown in FIG. 7, the subject displayed on the screen is photographed from photographing time point 1 at which the photographing is initiated to photographing time point 5 at which the photographing is finished. As shown in FIGS. 7A to 7E, the subject displayed on the screen is photographed at photographing time points 1 to 5, so that the photographs of the user turning his head in one direction are taken.

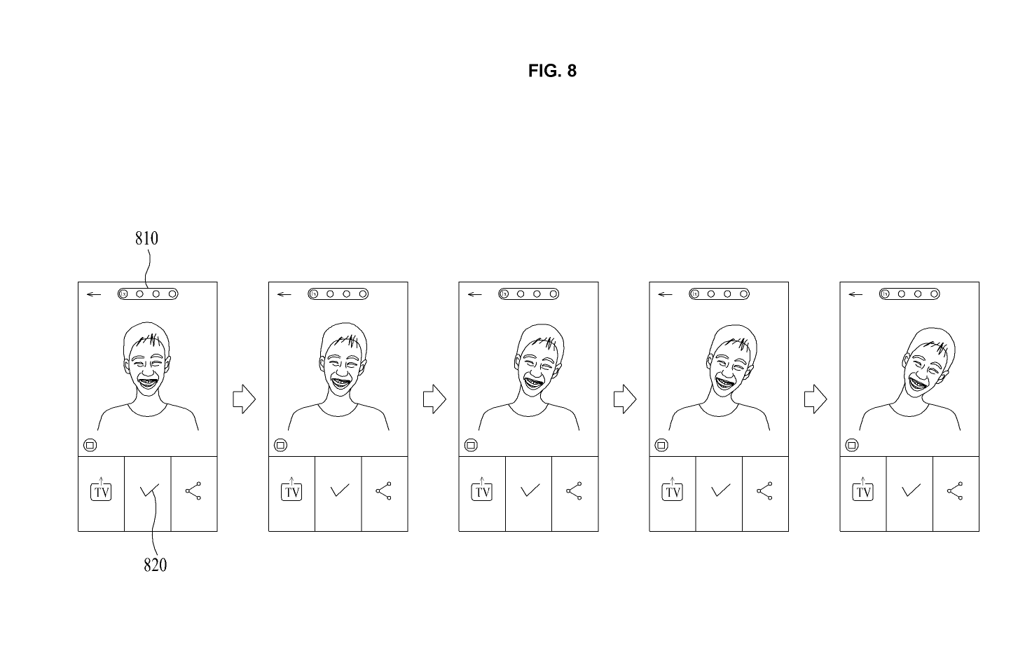

When the GIF burst mode photographing is finished, the photographs of FIGS. 7A to 7E are progressively displayed on the screen as shown in FIG. 8. In addition, a speed control function 810 which may controls the displaying speed of the photographs on a partial area in the screen, for example, to be 1, 2, 4 or 6 times thereof, and a storage button 810 which is configured to store the moving photograph based on the photographs in a GIF file format are displayed. That is, when the displaying speed of the photographs is controlled by using the speed control function 810 to be twice, the photographs are progressively changed and displayed at the rate of twice. In this case, when the storage button 820 is selected by the user, the photographs of FIGS. 7A to 7E which are changed and displayed at the rate of twice are stored in a GIF file.

Referring FIG. 2 again, as the determination result of the step S240, when the GIF mode is executed by the user input, a moving photograph of the displayed subject is generated by using the GIF video mode photographing in step S260. In detail, the displayed subject is photographed, for example, in the same format as that of the video by using the video function for the time determined by the user (in this embodiment, the displayed subject is photographed for the time taken to push the photographing button) such that the moving photograph of the subject is generated by using the photographed video (or photographs or images) in steps S261 and S262.

When the moving photograph of the displayed subject is generated by the video function in the step 260, the moving photograph is displayed on the screen. In addition, when the storage button previously provided is selected by the user, the generated moving photograph is stored in a GIF file format in steps S270 and S280.

In this case, the video of a single session may be obtained through the GIF video mode photographing as a plurality of video clips based on the photographing input of the user, such that the video clips are displayed on the single screen. The video of the single session may be a video unit obtained during the single video photographing such that the video has a preset length (for example, a time length of the video or an entire memory size of the video). That is, the video of a single session may be obtained as a plurality of video clips through the GIF video mode photographing and the moving photograph may be generated by using the obtained video clips.

While the GIF video mode photographing is performed, the GIF video mode photographing may enable the video clips to be displayed on a plurality of screen blocks. Since the video of a single session is freely obtained as the video clips, the video clips may be automatically displayed on the single screen.

For example, the video clips may be progressively obtained through the GIF video mode photographing in response to the repeated photographing input of the user. In detail, when a first photographing input of the user occurs in the mode corresponding to the GIF video mode photographing, a first video clip of the single session video may be photographed and obtained while the first photographing input is maintained. In this case, as the first video clip is photographed and obtained, a first real time bar segment representing that the first video clip is being obtained may be displayed on a part of a user input area, for example, a video area of the single session placed at an upper end. In this case, a traverse length of the video area of the single session may represent a preset length of the video of the single session (a time length of a video or an entire memory size of a video) and a traverse length of the bar segment may represents a time length of a memory size of the video clip.

In addition, after the first photographing input is completed, when the second photographing input occurs, a second video clip of the single session video may be photographed and obtained while the second photographing is maintained. Likewise, as the second video clip is photographed and obtained, a second real time bar segment representing that the second video clip is being obtained may be displayed on the video area of the single session placed at an upper end of the user input area.

The number of the video clips and each size of them may be controlled in accordance with the number of times of repeating the photographing input of the user based on the preset length of the single session video. For example, when the photographing input of the user is repeated twice so that the photographing of the single session video of the preset length is completed, the single session video may include two video clips. When the photographing input of the user is repeated three times so that the photographing of the single session video of the preset length is completed, the single session video may include three video clips.

In this case, the fact that the photographing input of the user is repeated so that the photographing of the single section video having a preset length is finished represents that the time length of each video clip obtained through the repeated photographing inputs of the user or the total memory size thereof satisfies the preset length of the single session video.

Thus, the process of obtaining the single session video as the video clips may be finished in accordance with whether the real time bar segment displayed by the photographing input of the user occupies the entire area of the single session video.

However, the embodiment is not limited to the above, but the process of obtaining the single session video as the video clips may be finished based on the photographing completion input of the user generated from the photographed object displayed on the user input area. In addition, the single session video may be obtained as a single video clip without the need to necessarily obtain the single session video as the video clips.

As described above, the number of the repeated photographing inputs of the user may be freely controlled by the user while the video clips are obtained through the photographing, so that an additional process of setting the number of video clips is omitted.

In addition, at least one of the video clips may be deleted based on a user deletion input generated from the user interface during the process of obtaining the video clips, and the video clip may be obtained after an option is applied to each video clip based on a user option input.

In advance, after the number of video clips is determined, the GIF video mode photographing may enable a plurality of screen blocks to be automatically generated based on the number of video clip. For example, when the video clips include first to third video clips, after it is confirmed that the number of video clips is three, the first to third screen blocks corresponding to the first to third video clips may be generated.

To the contrary, as the determination result of the step S230, when the general photographing mode is selected as the photographing mode in response to the user input, as well as the general photograph and video, the moving photograph may be generated in the general photographing mode.

FIG. 3 is a view in detail illustrating the process of generating a moving photograph by using a moving effect. As shown in FIG. 3, a moving effect or a moving sticker to be applied to the displayed subject is selected based on a user input in step S310.

The moving effect or moving sticker that is applied to the subject is provided by the application that provides the method of the embodiment. The moving effect may include various effects, such as a moving rabbit ear effect, a moving cloud effect, a moving heart effect, a rising heart balloon effect, a moving butterfly effect, etc.

When the moving effect to be applied is selected in response to the user's input or selection in step S310, the selected moving effect is applied to the subject displayed on the screen in step S320 and it is determined in step S330 whether a photographing command input by the user is received.

In step S320, the location of the subject to which the moving effect selected by the user will be applied may be determined based on the object included in the subject photographed by the camera, and then the selected moving effect may be applied to the determined location of application. For example, if the moving effect selected by the user is an effect in which a rabbit's moving ears are applied to a human's head, the location of the human's head is acquired from the photographed subject, and then the rabbit's ears are applied to the acquired location of the head.

In the step S320, when a movement occurs in the subject displayed on the screen due to the movement of the user who is photographing the subject, the location of the effect to be applied may be also changed in accordance with the occurring movement. It may be apparent that when the effect selected by the user is not applied to the subject displayed on the screen, the effect may not be applied to the subject, and the user may be notified that the effect in question is an effect that is not applied to the subject.

As the determination result of step S330, when a photographing command is received in accordance with the user's input, the subject displayed on the screen and the moving effect applied to the subject are captured to generate a capture image, and the generated capture image is displayed on the screen in steps S340 and S350.

In this case, the capture image generated in step S340 refers to an image in which both the subject and the moving effect have been captured. When a storage button present on the screen is pressed by the user, the generated capture image may be stored. The generated or stored capture image may be shared via at least one predetermined application, for example, a messenger service such as LINE, KakaoTalk or the like, BAND, a social network service (SNS), or the like.

A moving photograph in which in the capture image displayed in step S350, the subject is maintained in a capture state and only the applied moving effect is moving is generated in step S360.

In this case, in the step S360, when a moving photograph generation button formed in a partial area of the capture image displayed in the step S350 or a partial area of the screen is pressed or selected by the user, a moving photograph that enables only the applied moving effect to move in the capture image may be generated.

When the moving photograph is generated in step S360, whether to store the moving photograph generated based on the user's input is determined in step S270. When the storage button is selected by the user's input, the generated moving photograph is stored in a file such as a GIF file in step S280.

It will be apparent that the moving photograph generated in the step S270 and the moving photograph stored in the step S280 may be shared through at least one predetermined application such as a messenger service including as LINE or KakaoTalk, BAND, an SNS, etc.

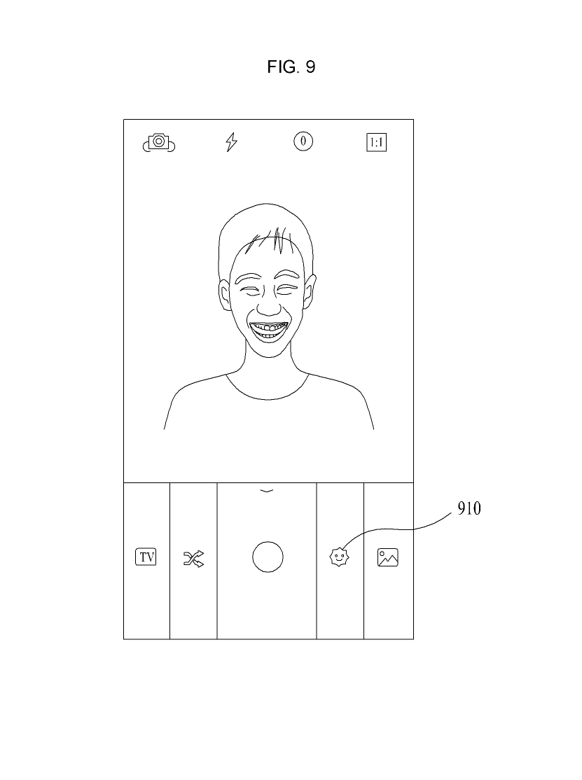

Hereinafter, a process of generating a moving photograph by using the moving effect or sticker depicted in FIG. 3 will be described in detail with reference to FIGS. 9 to 12.

FIGS. 9 to 1 are views illustrating the method of generating a moving photograph by applying a moving effect.

Referring to FIGS. 9 to 12, when an application that performs an embodiment is executed by a user, the subject photographed by a camera provided in or connected to a device to which the application is installed is displayed on a partial area of a screen 410, as in an example shown in FIG. 9.

In this case, a changing unit or setting unit capable of changing or setting various functions related to the photographing of the camera may be displayed on the partial area of the screen on which the subject is displayed. A user interface used for the changing of photographing mode, the checking of a stored image, and the selection of an effect to be applied may be displayed on a partial area of the screen.

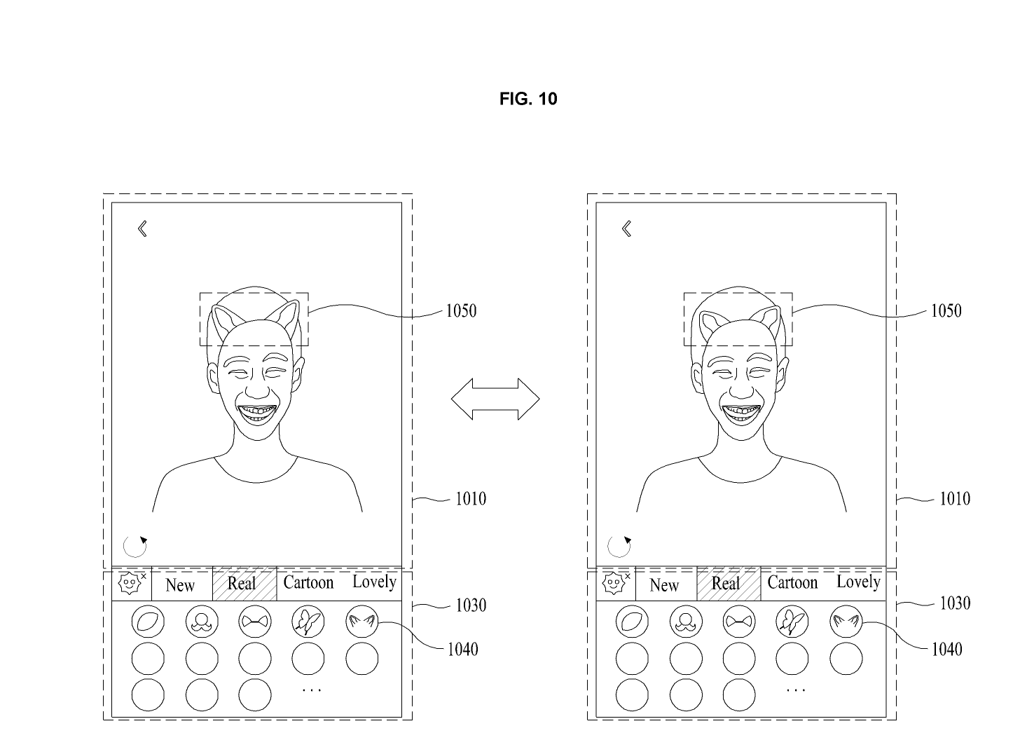

In FIG. 9, when an effect selection button 910 which enables a user to select a moving effect is selected by the user in the state that the photographing mode is the general photographing mode, various applicable moving effects or stickers 1030 are displayed in a partial area of the screen, as in an example shown in FIG. 10.

When any one of the various moving effects provided by the application, for example, the moving rabbit ears 1040 shown in FIG. 10, is selected, the selected rabbit ears 1040 search for the target object of the subject (in this case, a human), acquire the location of the human's head, and apply selected rabbit ears 1050 to the acquired location of the head.

The rabbit ears 1050 applied to the subject repeatedly moves from a form in which a rabbit' ears are raised, such as that shown in the left view of FIG. 10, to a form in which the rabbit's ears are lowered, such as that shown in the right view of FIG. 10. It will be apparent that the movement of the rabbit's ears is not limited to the movement between the raising shape of rabbit' ears and the bent shape of the rabbit's ear, but may include a movement in which the rabbit's ears move laterally.

As described above, when the rabbit ear effect 1040 is selected by the user in FIG. 10, the moving rabbit ears 1050 are applied to the location of the human's head which is being photographed by the camera, such that the moving rabbit ears attached to the human's head are displayed on the screen. In this case, when the movement of the human occurs on the screen, the location of the human's head is acquired in real time, and the selected rabbit's ears are applied to the location of the human's head acquired in real time.

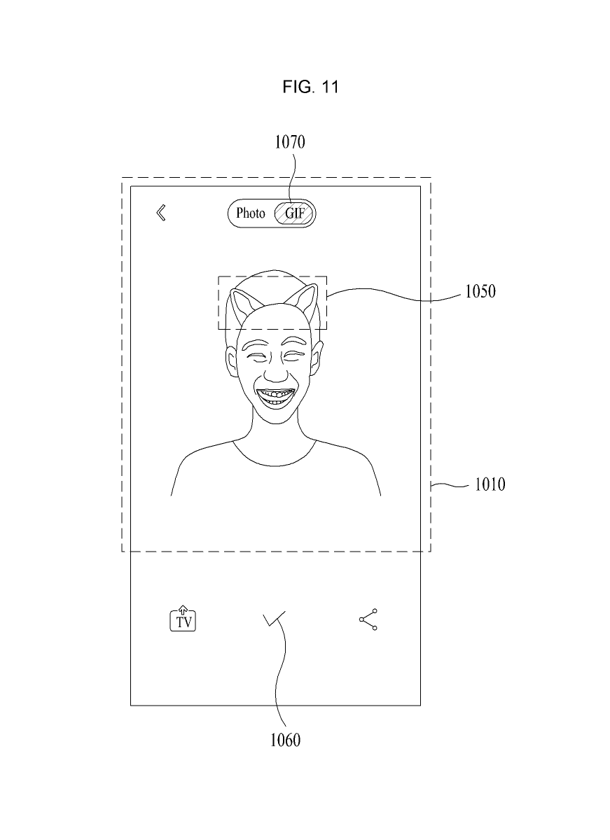

When a photographing command is received in response to a user's input in the state that the moving effect is applied to the subject, as shown in FIG. 10, the image displayed on the partial area 310 of the screen is captured at the time when the photographing command is received to generate a capture image, as in an example shown in FIG. 11.

In this case, since the generated capture image is an image captured in the state of being displayed on the screen at the time when the photographing command is received, the moving rabbit ears are also in the state of being captured without movement.

When the capture image is generated, the capture image is displayed on the screen as shown in FIG. 11, and a button 1070 configured to generate a moving photograph, for example, a GIF button is generated in a partial area of the capture image. In addition, a storage button 060 configured to store the capture image is displayed, as shown in FIG. 5.

When the storage button 1060 is selected by the user, the capture image captured on the screen is stored in a photograph file with a specific format, such as a JPG file.

Furthermore, when one of the sharing applications is selected by the user, the capture image may be shared with another person through the selected application.

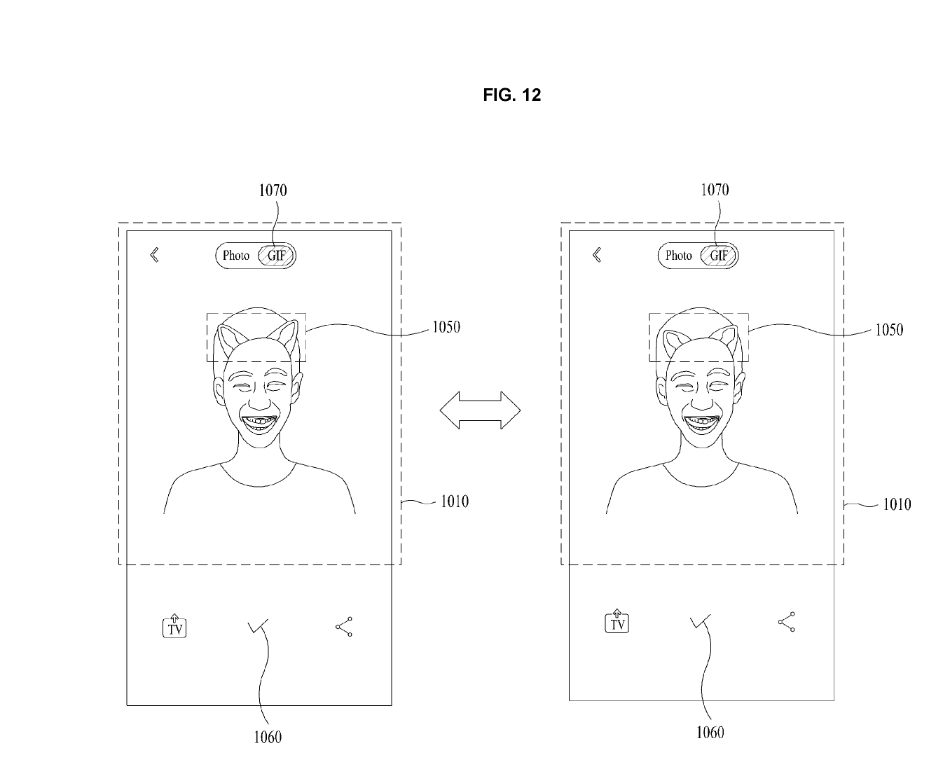

In contrast, when the user selects the GIF button 1070 configured to generate a moving photograph in FIG. 11, the GIF button 1070 is activated, and the subject is maintained in the captured state and the applied moving effect is realized (in this case, only the rabbit's moving ears move at a captured location) in the capture image, as shown in FIG. 12. Accordingly, the rabbit's ears repeatedly move from a form in which the rabbit's ears have been raised, such as that shown in the left view of FIG. 12, to a form in which the rabbit's ears have been bent, such as that shown in the right view of FIG. 12.

In this case, the generated moving photograph is displayed on the partial area of the screen, thereby enabling the user to determine whether to store or share the generated moving photograph.

In the same manner as the capture image, when the moving photograph is generated, the storage button 370 configured to store the moving photograph is displayed on the partial area of the screen.

When the storage button 1060 is selected by the user, the moving photograph generated on the screen is stored in a file with a predetermined format, for example, a GIF file.

Furthermore, when any one of the sharing applications provided by a sharing function is selected by the user, the moving photograph may be shared with another person through the selected application.

The buttons provided through the user interface of FIGS. 9 to 12 are not limited to specific locations. The locations and functions of the buttons may be determined by a provider who provides a service in accordance with the embodiment.

Of course, the moving effects described in FIGS. 9 to 12 may be applied to a video function of the general photographing mode as well as the photographing function of the general photographing mode. In addition, the moving effects may be applied to the GIF bust mode photographing and the GIF video mod photographing of the GIF photographing mode. For example, in the GIF bust mode photographing, when the moving effect is selected, the predetermined number of photographs may be progressively taken in the state that the moving effect is applied, such that the moving photograph is generated in the GIF file format.

As described above, according to the method of generating a moving photograph according to an embodiment, after switching to the GIF photographing mode provided to generate the moving photograph, a plurality of photographs are taken by selecting the GIF burst mode or GIF video mode in which photographs are progressively taken, such that the moving photograph of a subject is automatically generated, thereby generating a moving photograph of the subject without requiring relevant expert knowledge.

According to an embodiment, various types of moving effects may be applied to a subject, so that a moving photograph having various effects may be generated.

The method according to an embodiment may be applied to a device equipped with a camera, such as a smart phone, and an application according to an embodiment may be installed to a smart phone, so that various moving photographs of a subject or a moving photograph having various effects are provided to a user of the smart phone, thereby providing various types of amusement to the user.

As described above, the method according to an embodiment may support all four types of photography including the photographing and video-graphing in the general photographing mode and the GIF burst mode photographing and GIF video mode photographing in the GIF photographing mode, thereby applying effects such as a moving effect in each mode.

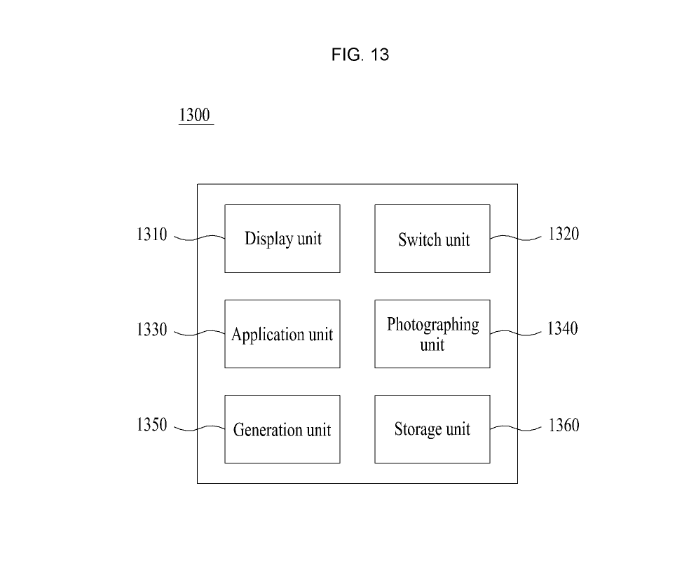

FIG. 13 shows the configuration of an apparatus for generating a moving photograph according to an embodiment, which performs the method of generating a moving photograph described with reference to FIGS. 2 to 12.

In this case, the apparatus 1300 for generating a moving photograph may be configured to be included in any device equipped with a camera.

Referring to FIG. 13, the apparatus 1300 for generating a moving photograph according to an embodiment includes a display unit 1310, a switch unit 1320, an application unit 1330, a photographing unit 1340, a generation unit 1350, and a storage unit 1360.

The display unit 1310 is a means for displaying all data related to the inventive concept, including a subject photographed by the camera of the apparatus, a capture image captured by the camera, a moving photograph generated by using the capture image, a moving photograph generated through the GIF photographing mode, a user interface, etc.

In this case, the display unit 1310 is a means for displaying data, and may be, for example, a touch screen provided in a smart phone.

The switch unit 1320 performs mode switching between the general photographing mode and the video-graphing mode, that is, the above-described GIF photographing modes in response to the input of a user.

In this case, as described above, the switch unit 1320 may switch between the general photographing mode and the video-graphing mode through the switch button displayed on the screen.

When one of the effects or stickers provided in accordance with the embodiment is selected by the user, the application unit 1330 applies the selected effect to the subject.

In this case, the application unit 1330 may determine the location of a subject to which the selected effect is to be applied based on an object included in the subject, and may apply the selected effect to the determined location of application.

For example, when the effect selected by the user is a moving effect, for example, an effect that rabbit's moving ears are applied to a human's head, the application unit 1330 acquires the location of the human's head from the photographed subject, and applies the rabbit's moving ears to the acquired location of the head.

In this case, when a movement occurs in the subject displayed on the screen due to the movement of the user who photographs the subject, the application unit 1330 may change and apply the location of the effect applied in accordance with the occurring movement.

The photographing unit 1340 photographs the subject displayed on the display unit 1310 in one of the general photographing mode and the GIF photographing mode provided in accordance with an embodiment.

In this case, the photographing unit 1340 may take a plurality of photographs or images of the displayed subject in the GIF burst mode or the GIF video mode provided in the GIF photographing mode to generate a moving photograph.

That is, when the GIF burst mode provided in the GIF photographing mode is selected, the photographing unit 1340 may progressively photograph the displayed subject the predetermined number of times in the GIF burst mode. When the GIF video mode is selected, the photographing unit 1340 may photograph the displayed image by using the video function for the time determined by the user.

In addition, when the moving effect is selected in the general photographing mode or the GIF photographing mode, the photographing unit 1340 may take the photographs to generate a moving photograph including the moving effect.

The generation unit 1350 generates the moving photograph using the photographs or image photographed by the photographing unit 1340.

In this case, the generation unit 1350 may generate a moving photograph of the displayed subject by using the photographs progressively taken in the GIF burst mode. In addition, the generation unit 1350 may generate the moving photograph of the displayed subject by using the images progressively taken in the GIF video mode.

Of course, when the moving effect is applied in the general photographing mode, the generation unit 1350 may capture the subject and the applied moving effect in compliance with a photographing command issued by the user, and may generate the moving photograph in which the subject is maintained in a captured state and only the effect-applied part is moving.

The storage unit 1360 may store all data required for the performance of the inventive concept, such as an algorithm, an application, various effect data, a capture image, a moving photograph, a video, etc.

In this case, when the storage button is selected in the state that the moving photograph is generated and displayed, the storage unit 1360 may store the moving photograph in a GIF file.

Of course, it will be apparent to those skilled in the art that the apparatus in accordance with an embodiment can perform all functions mentioned in the method described above.

The systems or apparatus described herein may be implemented using hardware components, software components, and/or a combination thereof. For example, devices and components described therein may be implemented using one or more general-purpose or special purpose computers, such as, but not limited to, a processor, a controller, an arithmetic logic unit (ALU), a digital signal processor, a microcomputer, a field programmable gate array (FPGA), a programmable logic unit, a microprocessor or any other device capable of responding to and executing instructions in a defined manner. A processing device may run an operating system (OS) and one or more software applications that run on the OS. The processing device also may access, store, manipulate, process, and create data in response to execution of the software. For the sake of easy understanding, an embodiment of the inventive concept is exemplified as one processing device is used; however, one skilled in the art will appreciate that a processing device may include multiple processing elements and multiple types of processing elements. For example, a processing device may include multiple processors or a processor and a controller. In addition, other processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The methods according to embodiments may be implemented in the form of program instruction executable through various computing devices and may be recorded in a computer-readable medium. The computer-readable medium may also include program instructions, data files, data structures, and the like independently or in the form of combination. The program instructions recorded in the medium may be those specially designed and constructed for the embodiment or may be well-known and available to those skilled in the computer software arts. Examples of the computer-readable medium may include magnetic media such as hard disks, floppy disks, and magnetic tape; optical media such as CD ROM disks and DVD; magneto-optical media such as floptical disks, and hardware devices that are specialized to store and perform program instructions, such as read-only memory (ROM), random access memory (RAM), flash memory, and the like. Examples of program instructions may include both machine code produced by a compiler and high-level code executed by the computer using an interpreter. The described hardware devices may be configured to operate as one or more software modules to perform the operations of the above-described embodiments, and vice versa.

According to the embodiments of the inventive concept, a moving photograph of a subject may be automatically generated by using a plurality of photographs obtained by progressively photographing the subject when a specific mode is selected after switching to a mode such as a GIF photographing mode which is provided to generate a moving photograph.

According to the embodiments of the inventive concept, since various types of moving effects may be applied to the subject, the moving photographs having various effects may be made.

The embodiments of the inventive concept may be applied to a device equipped with a camera, such as a smart phone, and an application related to the embodiments may be installed to a smart phone, so that various moving photographs of a subject or various moving photographs having various effects are provided to a user of the smart phone, thereby providing various types of amusement to the user.

Although being described with reference to specific examples and drawings, modifications, additions and substitutions on embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Therefore, other implementations, other embodiments, and equivalents to the attached claims also fall within the scope of the attached claims

What is claimed is:

1. A method of generating a moving photograph, the method comprising:
displaying a subject photographed by a camera;
switching to a moving photograph mode in response to an input of a user;
progressively taking photographs of the displayed subject by using a photographing mode provided by the moving photograph mode; and
generating a moving image of the displayed subject by using the progressively taken photographs.

2. The method of claim 1, wherein, when a first mode is selected from photographing modes provided in the moving photograph mode, the taking of the photographs is performed by progressively taking a predetermined number of photographs in the first mode.

3. The method of claim 1, wherein, when a second mode is selected from photographing modes provided in the moving photograph mode, the taking of the photographs is performed by photographing the displayed subject by using a video function for a time set by the user.

4. The method of claim 1, further comprising:
displaying the generated moving photograph; and
when a storage button configured to store the generated moving photographs is selected by the user, storing the moving photograph in a graphics interchange format (GIF) file.

5. The method of claim 1, further comprising, when the user selects one from effects, applying the selected effect to the displayed subject,
wherein the taking of the photographs is performed by progressively photographing the subject to which the selected effect is applied.

6. The method of claim 5, wherein the applying of the selected effect comprises determining a location in the subject to which the selected effect is applied, based on an object included in the subject, and applying the selected effect to the determined application location.

7. An apparatus for generating a moving photograph, the apparatus comprising:
a display unit configured to display a subject photographed by a camera;
a switch unit configured to switch to a moving photograph mode in accordance with an input of a user;
a photographing unit configured to progressively taking photographs of the displayed subject by using a photographing mode provided by the moving photograph mode; and
a generation unit configured to generate a moving image of the displayed subject by using the photographs progressively taken.

8. The apparatus of claim 7, wherein, when a first mode is selected from photographing modes provided in the moving photograph mode, the photographing unit progressively takes a predetermined number of photographs of the displayed subject in the first mode.

9. The apparatus of claim 7, wherein, when a second mode is selected from photographing modes provided in the moving photograph mode, the photographing unit takes photographs the displayed subject by using a video function for a time set by the user.

10. The apparatus of claim 7, further comprising a storage unit configured to store the moving photograph in a Graphics Interchange Format (GIF) file when a storage button configured to store the generated moving photograph is selected by the user in a state that the generated moving photograph is displayed on the display unit.

11. The apparatus of claim 7, further comprising an application unit configured to apply an effect to the displayed subject when the user selects the effect from effects,
wherein the photographing unit progressively photographs the subject to which the selected effect is applied.

12. The apparatus of claim 11, wherein the application unit determines a location in the subject to which the selected effect is applied, based on an object included in the subject, and applies the selected effect to the determined application location.
